(19) United States
(12) Patent Application Publication
(10) Pub. No.: US 2013/0084034 A1
(43) Pub. Date: Apr. 4, 2013

(54) BEARING WITH HIGH-LOAD RADIAL AND AXIAL CAPABILITES INCLUDING A THERMAL COMPENSATION ELEMENT AS NEEDED

(71) Applicants: Marion Jack INCE, MOUNT HOLLY, NC (US); Joseph T. GRIFFIN, MATHEWS, NC (US); Charles SCHWAB, FORT MILL, SC (US)

(72) Inventors: Marion Jack INCE, MOUNT HOLLY, NC (US); Joseph T. GRIFFIN, MATHEWS, NC (US); Charles SCHWAB, FORT MILL, SC (US)

(73) Assignee: SCHAEFFLER TECHNOLOGIES AG & CO. KG, Herzogenaurach (DE)

(21) Appl. No.: 13/617,899

(22) Filed: Sep. 14, 2012

Related U.S. Application Data
(60) Provisional application No. 61/542,397, filed on Oct. 3, 2011.

(51) Int. Cl. F16C 19/54

(52) U.S. Cl. 384/455

(57) ABSTRACT

A bearing assembly that includes both radial and axial roller elements. The bearing assembly can be used in applications requiring a low friction bearing requiring high radial and axial load carrying characteristics. The bearing assembly has an inner ring with a radially outwardly extending rim, an outer ring with a radially inwardly extending rim, radial and axial rollers, and cage segments arranged between the inner and outer ring. The axial rollers are arranged in the cage segments to form axial roller assemblies and the radial rollers are interdisposed between the axial roller assemblies with the radial rollers and the axial rollers being fully encompassed within the inner ring and the outer ring.

### FIELD OF INVENTION

The present invention relates generally to bearings and more particularly to a bearing that has both radial and axial roller elements. The bearing can be used, for example, in applications requiring a low-friction bearing with high radial and axial load carrying characteristics.

### BACKGROUND OF THE INVENTION

Bearings are used for a wide variety of automotive applications. For example, bearings can be used in vehicle transmissions and as axle-differential bearing supports.

Bearing assemblies which combine radial and axial roller bearings are known. Many known combination bearings have a radial cage assembly and an axial cage assembly. These bearings are expensive to manufacture, have a limited load-carrying capacity, and require a large envelope space for installation.

See, for example, U.S. Pat. No. 7,524,114, which discloses a combined axial and radial bearing design. The bearing includes radial bearings arranged between an inner ring and an outer ring and axial bearings axially offset from the radial roller bearings between the inner ring and the outer ring.

Another reference that discloses a bearing which combines radial and axial roller bearings is, for example, DE 28 10 116 A1. The bearing here teaches alternating radial and axial roller bearings arranged between inner and outer rings. The axial roller bearings are arranged in a cage and both the axial roller bearings and radial roller bearings protrude from the inner ring and/or the outer ring.

See also, for example, DE 859 699 and DE 68 08 805, for other examples of combined radial and axial roller bearings.

Tapered roller bearings are also known. These bearings are used in application where low-friction is not required. Additionally, tapered roller bearings are expensive to produce and typically have a lower capacity rating.

### SUMMARY OF THE INVENTION

The present invention is directed to a cost-effective bearing assembly which combines radial and axial rollers. Typically, the bearing assembly may be used in applications that require a low-friction bearing with high radial and axial load carrying capabilities. For example, the bearing assembly can be used in applications for automotive transmissions and axle-differential bearing supports. The bearing assembly may he used to replace existing bearings, such as tapered roller bearings, within the same or a smaller envelope space. Moreover, depending on the arrangement, the present invention typically exceeds the capacity rating for a tapered roller bearing.

Broadly, the present invention can be defined as a bearing, which has an inner ring which has a radial raceway formed on an outer circumferential surface of the inner ring and a radially outwardly extending rim forming an axial raceway on an inner surface of the radially outwardly extending rim, and an outer ring which has a radial raceway formed on an inner circumferential surface of the outer ring and a radially inwardly extending rim forming an axial raceway on an inner surface of the radially inwardly extending rim. A plurality of radial rollers, a plurality of axial rollers, and a plurality of cage segments are arranged between the inner ring and the outer ring. The axial rollers can be arranged, for example, snapped, in the cage segments to form axial roller assemblies, which allow for free rotation of the axial rollers while retaining and guiding the axial rollers. The radial rollers can be interdisposed between the axial roller assemblies, and the radial rollers and the axial rollers can be fully encompassed within the inner ring and the outer ring.

The axial raceway and the radial raceway of the inner ring can be orientated at 90° to each other and the axial raceway. Also, the radial raceway of the outer ring can be orientated at 90° to each other.

The cage segments can have a cut-out in a first surface, which is guided by the axial raceway of the outer ring to aid in lubrication and reduce friction.

The cage segments can be contoured such that the cage segments at least partially extend over a radial surface of the radial rollers.

The cage segments can have a cut-out in a second surface, which is guided by the axial raceway of the inner ring to aid in lubrication and reduce friction.

The cage segments are made of various materials, for example thermoplastic.

The axial rollers and the radial rollers can have the same diameter or equal diameters. The axial rollers and the radial rollers can also have different lengths, and the axial rollers can be shorter than the radial rollers.

The inner ring can have a radially outwardly extending hook formed at an end of the inner ring opposite the radially outwardly extending rim and a groove is formed in the outer circumferential surface of the inner ring, near the hook. Also, the inwardly extending rim of the outer ring can be bent axially outwardly so as to be flange connected together with the inner ring at the hook and groove of the inner ring so as to form a one-piece bearing assembly.

Alternatively, the outer ring can have a radially inwardly extending hook formed at an end of the outer ring opposite the radially inwardly extending rim and a groove is formed in the inner circumferential surface of the inner ring, near the hook. Also, the outwardly extending rim of the inner ring can be bent axially outwardly so as to be flange connected together with the outer ring at the hook and groove of the outer ring so as to form a one-piece bearing assembly.

The bearing assembly can further comprise a thermal compensation element, which can be comprised of elastomeric material, arranged in the bearing assembly so as to maintain an axial preload on the axial rollers at all times.

The bearing assembly can also further comprising a washer, which has a raceway that can contact the radial rollers and the axial rollers. The washer can be disposed between the thermal compensation element and the radial rollers and the axial rollers.

The thermal compensation element can be arranged axially between the radially inwardly extending rim of the outer ring and the washer.

### BRIEF DESCRIPTION OF THE DRAWINGS

The present invention will be further understood and appreciated by reading the following description in conjunction with the accompanying drawings, in which:

FIG. 1 is a cross-sectional view of the bearing assembly of the present invention;

FIG. 2 is a sectional view (A-A) taken from FIG. 1 with the cage element removed;

FIG. 3 is a side view of a cage segment;

FIG. 4 is an end view of the cage segment and axial roller assembly;

FIG. 5 is a top view of the cage segment and axial roller assembly;

FIG. 6 is a side view of an alternative embodiment of the cage segment;

FIG. 7 is a sectional view of the cage segment of FIG. 7;

FIG. 8 is a sectional view of the bearing with the cage segment of FIG. 7; and

FIG. 9 is a sectional view of the bearing with a thermal compensation element and washer.

### DETAILED DESCRIPTION OF THE INVENTION

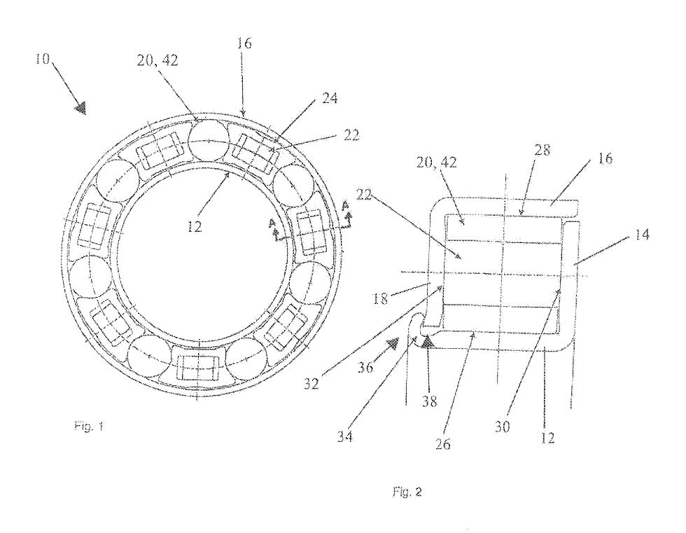

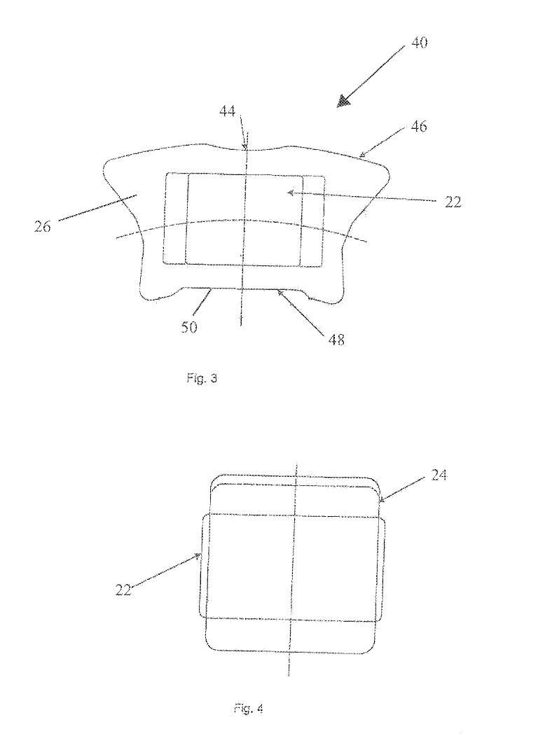

FIGS. 1 and 2 illustrate a side view of a bearing arrangement 10. The bearing arrangement 10 includes an inner ring 12 which has radially outwardly extending rim 14, an outer ring 16 which has a radially inwardly extending rim 18, radial rollers 20, axial rollers 22, and a cage segments 24, which may he made out of thermoplastic.

The axial rollers 22 are arranged, or snapped, in the cage segments 24 and the cage segments 24 are interdisposed between the radial rollers 20. As a result of the configuration of the inner ring 12 and the outer ring 16, the inner ring 12 has two raceways, a radial raceway 26 and an axial raceway 30 and the outer ring 16 has two raceways, a radial raceway 28 and an axial raceway 32 on which the rollers 20, 22 and cage segments 24, 54 run. The raceways 26 28, 30, 32 are arranged to encompass the rollers 20, 22 and the cage segments 24, 54. The cage segments 24, 54 guide the axial rollers 22 and provide spacing and guidance to the radial rollers 20.

FIG. 2 is an enlarged sectional A-A of FIG. 1. The figure depicts the outwardly extending radial rim 14 of the inner ring 12 and the inwardly extending radial rim 18 of the outer ring 16. FIG. 2 further illustrates a radially outwardly extending hook 34 formed at an end 36 of the inner ring 12 opposite the radially outwardly extending rim 14 and a groove 38 formed in the radial raceway 26 of the inner ring 12, near the hook 34. Also, as shown, the inwardly extending rim 18 of the outer ring 16 is bent axially outwardly. The configuration of the inner ring 12 and the outer ring 16 allows the rings 12, 16 to he flange connected together, forming a one-piece bearing assembly. It should be noted that the configuration of the inner ring 12 and the outer ring 16 can also he reversed such that the outer ring 16 has a radially inwardly extending hook and a groove formed in the radial raceway 28 of the outer ring 16, near the hook and the outwardly extending rim 14 of the inner ring 12 is bent axially outwardly.

FIG. 3 shows a side view of a first embodiment 40 of the cage segment 24. The cage segment 24 is contoured such that the cage segment 24, at least partially, extends over a radial surface 42 of the radial rollers 20. The cage segment 24 has a first cut-out 44 in a first surface 46, which is guided by the radial raceway 28 of the outer ring 16 to aid in lubrication and to reduce friction. Also, the cage segment 24 has a second cut-out 48 in a second surface 50, which is guided by the radial raceway 26 of the inner ring 12 to also aid in lubrication and reduce friction. The cage segment 24 can be made out of various materials, for example thermoplastics.

FIG. 4 is an end view of the cage segment 24 and FIG. 5 is a top view of the cage segment 24. In FIGS. 4 and 5, the axial roller 22 is shown in an assembled state.

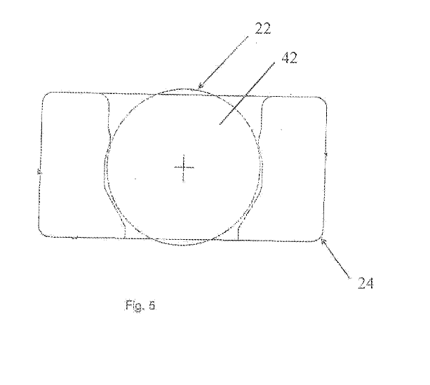

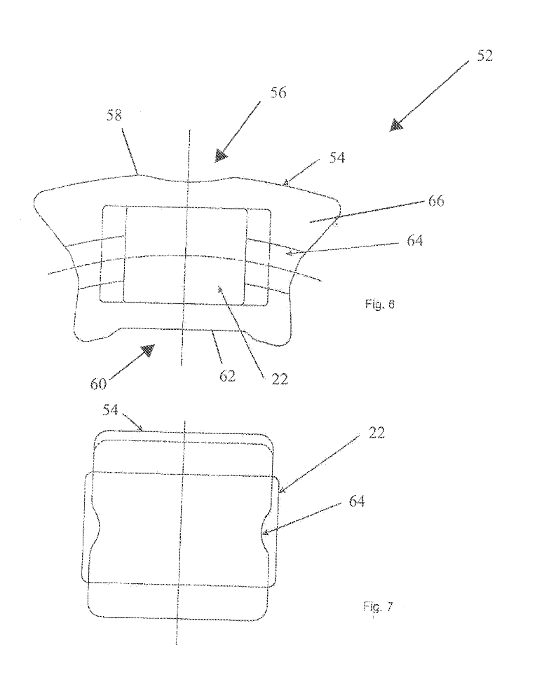

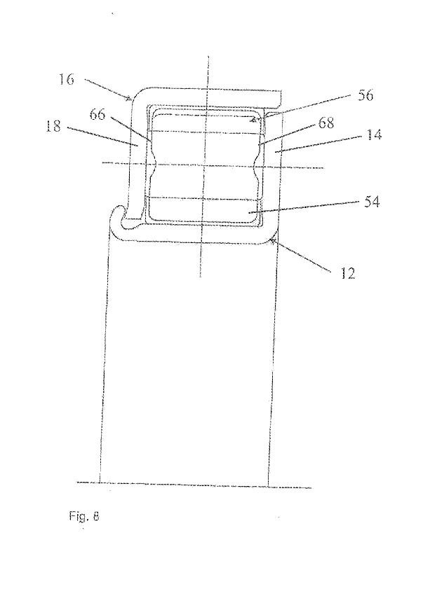

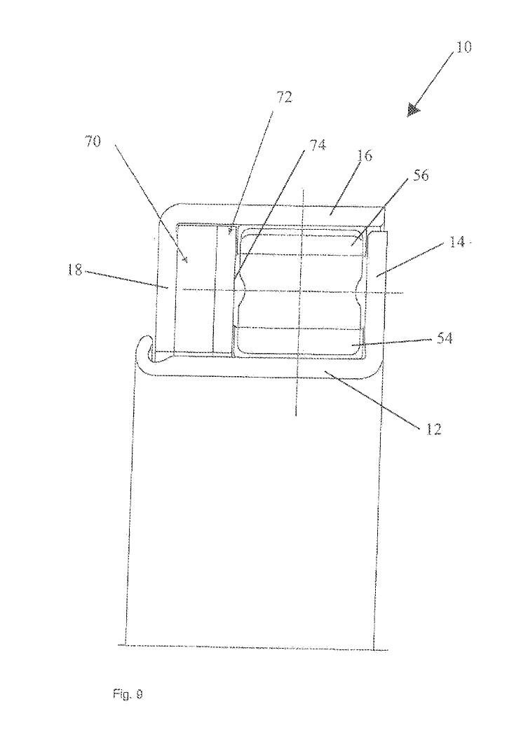

FIG. 6 shows a side view of a second embodiment 52 of a cage segment 54. The cage segment 54 is contoured such that the cage segment 54, at least partially, extends over the radial surface 42 of the radial rollers 20. Similar to the first embodiment 40, the cage segment 54 of the second embodiment 52 has a first cut-out 56 in a first surface 58, which is guided by the radial raceway 28 of the outer ring 16 to aid in lubrication and to reduce friction and the cage segment 54 has a second cut-out 60 in a second surface 62, which is guided by the radial raceway 26 of the inner ring 12 to also aid in lubrication and reduce friction. In this embodiment 52, the cage segment 54 also has a groove 64 formed in a third surface 66 and a fourth surface 68 (shown in FIG. 8), which are located between the first surface 58 and the second surface 62. As shown, the groove 64 can have a circumferential contour that is similar to the contour of the bearing assembly 10. The groove 64 is intended to aid in lubrication and to reduce friction.

FIG. 7 is an end view of the cage segment 54 and FIG. 8 shows a sectional view showing the cage segment 54.

FIG. 9 is an end view of the bearing assembly 10 which includes a thermal compensation element 70 arranged between the inner ring 12 and the outer ring 16. The thermal compensation element 70 is arranged integral with the bearing assembly 10 and maintains an axial preload on the axial rollers 22 at all times. Also, a washer 72, which may or may not be encapsulated and has an axial raceway 74 is also shown in FIG. 9. As illustrated, the washer 72 is arranged axially next to the cage segment 54 and rollers 20, 22 and the thermal compensation element 70 is arranged axially next to the washer 72 and contactable with the outer ring 16.

It should be noted that the present invention can be used in conjunction with various types of bearings and is not limited to roller bearings.

The present invention has been described with reference to a preferred embodiment. It should be understood that the scope of the present invention is defined by the claims and is not intended to be limited to the specific embodiment disclosed herein.

### REFERENCE CHARACTERS

10 Bearing Arrangement
12 Inner Ring
14 Radially Outwardly Extending Rim
16 Outer Ring
18 Radially Inwardly Extending Rim
20 Radial Roller
22 Axial Roller
24 Cage Segment
26 Radial Raceway
28 Radial Raceway
30 Axial Raceway
32 Axial Raceway
34 Hook
36 End of the Inner Ring
38 Groove
40 First Embodiment
42 Radial Surface
44 Cut-out
46 First Surface
48 Cut-out
50 Second Surface
52 Second Embodiment
54 Cage Segment
56 Cut-out
58 First Surface
60 Cut-out
62 Second Surface
64 Groove
66 Third Surface
68 Fourth Surface
70 Thermal Compensation Element
72 Washer
74 Axial Raceway

What is claimed:

1. A bearing assembly, comprising:
an inner ring having a radial raceway formed on an outer circumferential surface of the inner ring and a radially outwardly extending rim forming an axial raceway on an inner surface of the radially outwardly extending rim;
an outer ring haying a radial raceway formed on an inner circumferential surface of the outer ring and a radially inwardly extending rim forming an axial raceway on an inner surface of the radially inwardly extending rim;
a plurality of radial rollers;
a plurality of axial rollers; and
a plurality of cage segments arranged between the inner ring and the outer ring, the axial rollers being arranged in the cage segments to form axial roller assemblies which allow for free rotation of the axial rollers while retaining and guiding the axial rollers, the radial rollers being interdisposed between the axial roller assemblies, the radial rollers and the axial rollers being fully encompassed within the inner ring and the outer ring.

2. The bearing assembly as claimed in claim 1, wherein the axial raceway and the radial raceway of the inner ring are orientated at 90° to each other and the axial raceway and the radial raceway of the outer ring are orientated at 90° to each other.

3. The bearing assembly as claimed in claim 1, wherein the axial rollers are snapped into the cage segments.

4. The bearing assembly as claimed in claim 1, wherein the cage segments have a cut-out in a first surface, which is guided by the axial raceway of the outer ring to aid in lubrication and reduce friction.

5. The bearing assembly as claimed in claim 4, wherein the cage segments are contoured such that the cage segments at least partially extend over a radial surface of the radial rollers.

6. The bearing assembly as claimed in claim 5, wherein the cage segments have a cut-out in a second surface, which is guided by the axial raceway of the inner ring to aid in lubrication and reduce friction.

7. The bearing assembly as claimed in claim 1, wherein the cage segments are made of thermoplastic.

8. The bearing assembly as claimed in claim 1, wherein the axial rollers and the radial rollers have an equal diameter.

9. The bearing assembly as claimed in claim 1, wherein the axial rollers and the radial rollers have different diameters.

10. The bearing assembly as claimed in claim 1, wherein the axial rollers and the radial rollers have different lengths.

11. The bearing assembly as claimed in claim 10, wherein the axial rollers are shorter than the radial rollers.

12. The bearing assembly as claimed in claim 1, wherein the inner ring has a radially outwardly extending hook formed at an end of the inner ring opposite the radially outwardly extending rim and a groove is formed in the outer circumferential surface of the inner ring, near the hook, and the inwardly extending rim of the outer ring is bent axially outwardly so as to be flange connected together with the inner ring at the hook and groove of the inner ring so as to form a one-piece bearing assembly.

13. The bearing assembly as claimed in claim 1, wherein the outer ring has a radially inwardly extending hook formed at an end of the outer ring opposite the radially inwardly extending rim and a groove is formed in the inner circumferential surface of the inner ring, near the hook, and the outwardly extending rim of the inner ring is bent axially outwardly so as to be flange connected together with the outer ring at the hook and groove of the outer ring so as to form a one-piece bearing assembly.

14. The bearing assembly as claimed in claim 1, further comprising a thermal compensation element arranged in the bearing assembly so as to maintain an axial preload on axial rollers at all times.

15. The bearing assembly as claimed in claim 14, wherein the thermal compensation element is comprised of elastomeric material.

16. The bearing assembly as claimed in claim 14, further comprising a washer having a raceway that contacts the radial rollers and the axial rollers, the washer being disposed between the thermal compensation element and the radial rollers and the axial rollers.

17. The bearing assembly as claimed in claim 16, wherein the thermal compensation element is arranged axially between the radially inwardly extending rim of the outer ring and the washer.
